(19) United States
(12) Patent Application Publication
(10) Pub. No.: US 2019/0391901 A1
(43) Pub. Date: Dec. 26, 2019

(54) ADAPTIVE BASELINING AND FILTERING FOR ANOMALY ANALYSIS

(71) Applicant: CA, Inc., New York, CA (US)

(72) Inventors: Smrati Gupta, San Jose, CA (US); Anil Maipady, Santa Clara, CA (US)

(21) Appl. No.: 16/013,919

(22) Filed: Jun. 20, 2018

(51) Int. Cl. G06F 11/36; G06N 3/08; G06F 9/455

(52) U.S. Cl. CPC G06F 11/3608; G06F 11/3616; G06F 2009/45583; G06F 9/45558; G06N 3/08

(57) ABSTRACT

To adapt anomaly detection to changing canonical behavior and reduce the chances of feeding in feature value combinations that appear to be outliers but correspond to canonical behavior, multi-variate non-parametric density estimation is employed. An adaptive canonical behavior filter builds a sample dataset from observed time-series values of memory related metrics and then performs kernel density estimation on the sample dataset. With the resulting probability density function, the adaptive canonical behavior filter filters out subsequently observed time-series values of the memory related metrics that fall within a canonical behavior range that is specified/configured.

### BACKGROUND

The disclosure generally relates to the field of data processing, and more particularly to artificial intelligence.

Application performance management (APM) involves the collection of numerous metric values for an application. For a distributed application, an APM application or tool will receive these metric values from probes or agents that are deployed across application components to collect the metric values and communicate them to a repository for evaluating. The collected metric values are monitored and analyzed to evaluate performance of the application, detect anomalous behavior, and inform root cause analysis for anomalous behavior.

Many anomalies in application performance relate to memory management. One type of memory related anomaly is a memory leak. A memory leak is a scenario in which memory is incorrectly managed for a program or application. In the context of a Java® Virtual Machine (JVM), a memory leak occurs when objects that are no longer used by an application are still referenced. Since the objects are references, the JVM garbage collector cannot free the corresponding despite the objects not being used by an application. If unresolved, less memory will be available and pauses for garbage collection will increase in frequency. These will incur performance penalties on the application running within the JVM.

### BRIEF DESCRIPTION OF THE DRAWINGS

Embodiments of the disclosure may be better understood by referencing the accompanying drawings.

FIG. 1 is a conceptual diagram of a non-intrusive, lightweight memory anomaly detector.

FIG. 2 is a conceptual diagram of the lightweight anomaly detector 101 after the artificial neural network has been trained by the fuzzy rule-based classifier.

FIG. 3 is a flowchart of example operations for multi-phase memory anomaly detection with an artificial neural network and a fuzzy rule-based classifier.

FIG. 4 is a flowchart of example operations for extracting features from a time-series dataset of memory related metrics for an application to create the memory anomaly feature vector.

FIG. 5 is a conceptual diagram of an adaptive canonical behavior filter to filter out time slices of time-series values of metrics related to application behavior based on an adapting behavior baseline.

FIG. 6 is a flowchart of example operations for adapting a baseline of canonical behavior with density estimation of observed time slices of metric values.

FIG. 7 is a flowchart of example operations for filtering time slices based on an adaptive baseline as represented by a current PDF.

FIG. 8 depicts an example computer system with an adaptive canonical behavior anomaly analysis filter.

### DESCRIPTION

The description that follows includes example systems, methods, techniques, and program flows that embody embodiments of the disclosure. However, it is understood that this disclosure may be practiced without these specific details. In other instances, well-known instruction instances, protocols, structures and techniques have not been shown in detail in order not to obfuscate the description.

Introduction

A monitoring component of an APM application will likely use threshold alarms or univariate statistical analysis to detect memory anomalies. With a memory anomaly, such as a memory leak, there is not “one right” metric to monitor in order to detect a memory anomaly. Since multiple metric would be monitored, a machine-learning based multivariate pattern recognition can be used to detect memory anomalies. This would be a heavy solution since feeding in a stream of time-series data across multiple metrics into a machine learning algorithm would be computationally expensive. In addition, the monitoring component would be intrusive because it would be programmed to interface with the JVM to obtain the metric values or access JVM instrumentation counters. If JVM instrumentation counters are maintained in temporary files, then the monitoring component can access the temporary file and avoid interfacing with the JVM. However, the monitoring component would search the file for information about garbage collection operations. This would add latency overhead.

Lightweight Memory Anomaly Overview

A memory anomaly detector has been designed that is lightweight and non-intrusive. The lightweight, non-intrusive memory anomaly detector has been designed to extract features for classification by a rule-based classifier until a second classifier has been trained by the rule-based classifier. The memory anomaly detector correlates values in time-series data for selected memory related metrics (“correlated features”). This data can be efficiently collected by probes or agents without being intrusive with the application component (e.g., virtual machines (VMs)) being monitored. In addition, the memory anomaly detector derives additional features from the correlated values to present a smaller input vector to the two classifiers: a fuzzy rule-based classifier and an artificial neural network. This allows the memory anomaly detector to be “lightweight” because it is less computationally expensive to run a smaller artificial neural network. The fuzzy rule-based classifier applies fuzzy rules to the input vector and provides classification labels. The classification labels indicate a first probability/confidence that the input vector represents a pattern(s) that can be classified as a memory anomaly and a second probability/confidence that the input vector represents a pattern than can be classified as canonical memory behavior (i.e., not a memory anomaly). In addition to the fuzzy rule-based classifier providing output for application performance analysis, the input vector and labels used to train the artificial neural network (ANN). After being trained, the trained ANN is refined with supervised feedback (e.g., administrator or triage feedback) and presents its output of classification probabilities for application performance analysis.

### Example Illustrations for Memory Anomaly Detector

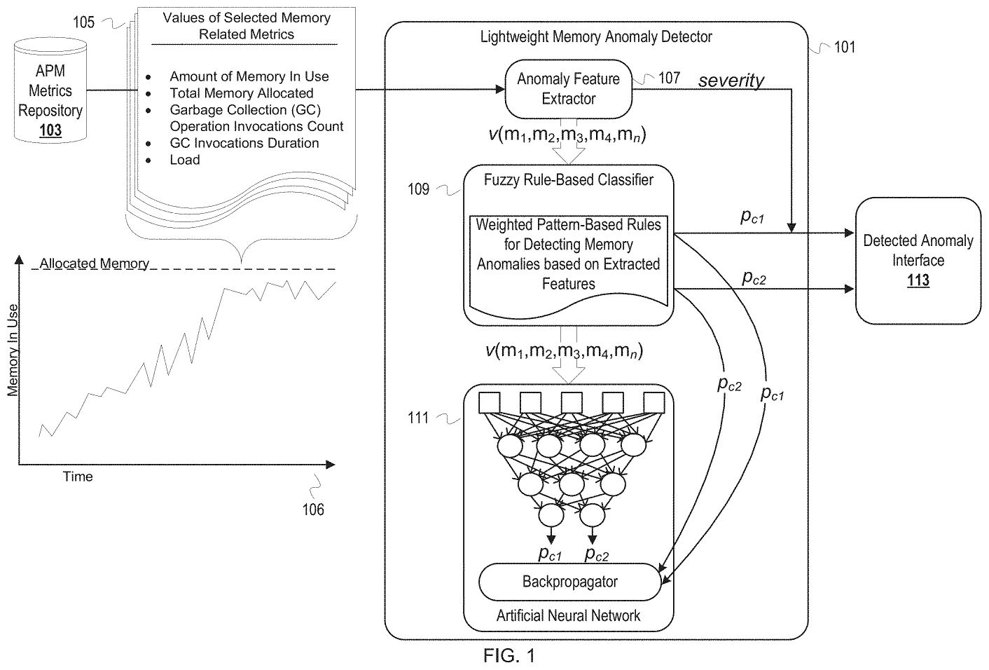

FIG. 1 is a conceptual diagram of a non-intrusive, lightweight memory anomaly detector. A lightweight memory anomaly detector 101 is in communication with an application performance management (APM) metric repository 103. The lightweight memory anomaly detector 101 (“detector”) uses classifiers to detect memory anomalies and outputs detected memory anomalies to a detected anomaly interface 113. The detected anomaly interface 113 can be an application or application component for monitoring an application and analyzing anomalous behavior of an application.

Probes or agents of an APM application will collect values of application metrics and store the collected metric values into the repository 103. The collected metric values are time-series data forming a time-series dataset because the collection is ongoing and the metric values are associated with timestamps. The repository 103 is hierarchically structured or at least indicates hierarchical relationships of the application components and corresponding metrics. The detector 101 is configured to obtain time-series values of metrics related to memory management. In this example, the detector 101 is configured to obtain time-series values of metrics for garbage collection operations of virtual machines. A distributed application can have multiple virtual machines that instantiate and terminate over the life of the distributed application. Thus, the detector 101 may be scanning several containers (e.g., folders or stores) or key-value entries that correspond to different virtual machines.

For each of these monitored virtual machines the memory management related metrics include total memory allocated to the VM, memory in use by the VM, counts of invocations of garbage collection operations (e.g., marksweep, scavenge, etc.), and duration of garbage collection operations. These memory management related metrics do not involve transaction traces or calling a Java® function to obtain the metric values, such as object age or number of created objects. Instead, probes obtain these metric values non-intrusively instead of. In addition to the memory management related metrics of each VM, the detector 101 obtains time-series values for the load on the application or application component supported by the VM. Disregarding interruptions and restarts of the application, the detector 101 continuously obtains these time-series values. Time-series values for these metrics for a time period is represented by the stack of time-series data 105. A graph 106 represents the memory in use over time as indicated in the time-series data 105. The graph 106 illustrates that the memory in use for a virtual machine (or aggregate of virtual machines) is approaching the allocated memory limit for the virtual machine, which would be anomalous behavior.

In FIG. 1, the functionality of the detector 101 has been logically organized into an anomaly feature extractor 107, a fuzzy rule-based classifier 109, and an artificial neural network (ANN) 111. Each of these are likely implemented as different code units (e.g., functions or subroutines), but implementation specifics can vary by developer, language, platform, etc. The anomaly feature extractor 107 extracts memory anomaly features from the time-series dataset 105 by reducing the size of input to be supplied to the fuzzy rule-based classifier 107 and the ANN 111 and by deriving memory anomaly features from one or more metrics indicated in the time-series dataset 105. To reduce the size of input, the anomaly feature extractor 107 uses the metric garbage collection (GC) operation invocations to exclude values of other metrics from consideration. The GC operation invocations will only occur at particular times across the time span corresponding to the time-series dataset 105. Accordingly, the GC operation invocations will be associated with fewer timestamps or time instants than included in the time-series dataset 105. To focus the analysis (i.e., reduce the input size for analysis by the classifiers), the anomaly feature extractor 107 selects values of other metrics that correlate with the GC operation invocations by time. The margin size is a configured value of the anomaly feature extractor 107. With the correlated metric values or across all memory in use values in the dataset 105, the anomaly feature extractor 107 derives other features, such as incremental slopes and a net slope of memory in use and GC operation durations. The anomaly feature extractor 107 also computes a severity value based on allocated memory and memory in use. The severity value represents how quickly the memory in use is approaching the allocated memory. The anomaly feature extractor 107 can supply the severity value to the detected anomaly interface 113 directly or pass it through the fuzzy rule-based classifier 109. The anomaly feature extractor 107 assembles the extracted features into an input vector represented as ν(m₁, m₂, m₃, m₄, mₙ), which flows to the fuzzy rule-based classifier 109.

The fuzzy rule-based classifier 109 is a set of rules for pattern-based detection of memory anomalies. The rules are weighted. The weights of breached or satisfied rules are aggregated into probabilities or confidence values associated with corresponding labels of a first classification “anomaly” and a second classification “no anomaly.” The weights and rules have been created based on expert knowledge of the application's behavior with respect to these memory management related metrics. As examples, a first rule may be that if the memory in use slope represents a rate of increase within a range of 12%-20% and load is not increasing during that same time sub-window, then the label “anomaly” is associated with a confidence value of 0.3. Confidence values associated with other “anomaly” rules would be aggregated with the 0.3. Similarly, rules corresponding to canonical behavior of the application's memory management metrics would be evaluated and have confidence weights are aggregated for satisfied rules to be associated with the label “no anomaly.” Finally, the fuzzy rule-based classifier 107 generates a confidence/probability value for the first classification label “anomaly” (depicted as p_{c1}) and for the second classification label “no anomaly” (depicted as p_{c2}). The fuzzy rule-based classifier 107 supplies the generated values to the detected anomaly interface 113. The fuzzy rule-based classifier 107 also supplies the generated values to the ANN 111 along with the input vector of extracted features for training.

The detector 101 trains the ANN 111 with the output from the fuzzy rule-based classifier. The ANN 111 forward feeds the input vector of extracted features through the connected neurons of ANN 111 and produces probabilities of the different classifications of“anomaly” and “no anomaly,” which is also depicted as p_{c1} and p_{c2} from the output layer of the ANN 111. A backpropagator of the ANN 111 then runs a back propagation algorithm with the output values from the fuzzy rule-based classifier 107 and the output layer of the ANN 111 to determine variance and adjust the bias or weights of the ANN 111. This training of the ANN 111 with output from the fuzzy rule-based classifier 107 continues until a specified training threshold (e.g., number of training vectors or training set size) is satisfied.

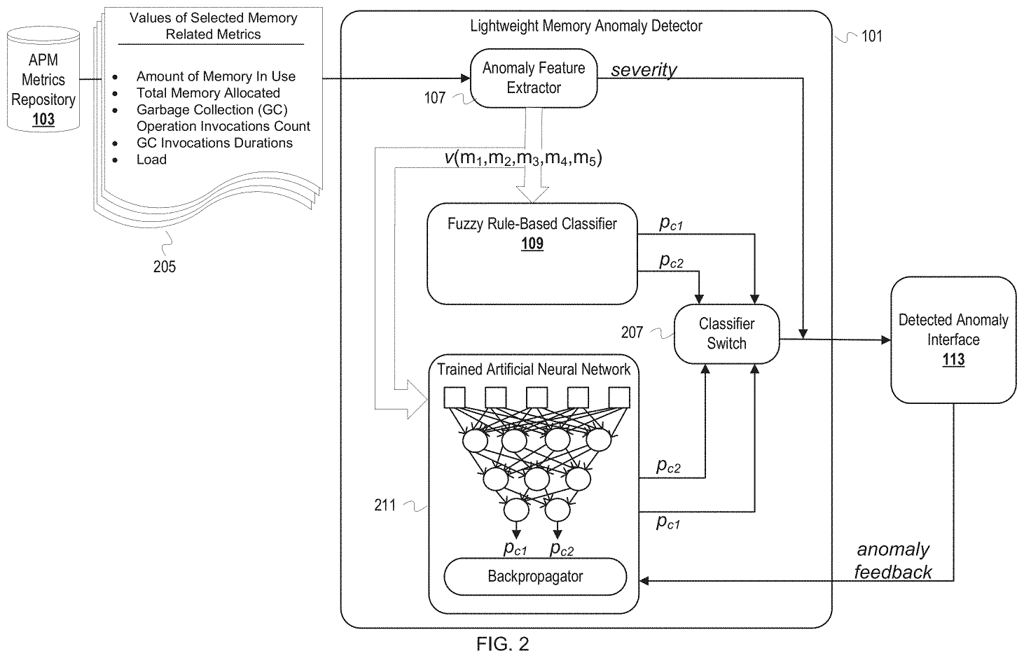

FIG. 2 is a conceptual diagram of the lightweight anomaly detector 101 after the artificial neural network has been trained by the fuzzy rule-based classifier. In FIG. 2, the ANN 111 has been trained and is now referred to as trained ANN 211. Extracted features input vectors from the anomaly feature extractor 107 are depicted as flowing directly to the trained ANN 211 instead of through the fuzzy rule-based classifier 109. The input vectors can flow directly (e.g., be directly passed as arguments in an invocation) to the ANN 111 while the ANN is being trained. In that case, the detector 101 would coordinate processing of the input vector by the ANN 111 with the output of the fuzzy rule-based classifier 109 to ensure the correct output is being used for backpropagation. FIG. 2 depicts a time-series dataset 205 for a different time span than in FIG. 1 since the ANN 111 has been trained, resulting in the trained ANN 211.

After training completes, the trained ANN 211 and the fuzzy rule-based classifier 109 output probabilities of the different classifications of anomaly versus no anomaly to a classifier switch 207. The classifier switch 207 evaluates the values output from the two classifiers 109, 211 to determine when the trained ANN 211 deviates from the classifier 109. When the trained ANN 211 deviates from the classifier 109, the switch 207 selects the output from the trained ANN 211 for communicating to the detected anomaly interface 113. If feedback indicates that the output of the fuzzy-rules based classifier 109 was incorrect, then the switch 207 can also switch to the ANN 211. The trained ANN 211 will eventually deviate from the classifier 109 because the trained ANN 211 is receiving anomaly feedback detected anomaly interface 113. The trained ANN 211 revises itself based on this feedback, which allows the trained ANN 211 to further adapt to behavior of the application being monitored. Behavior of an application can vary based on deployment attributes (e.g., computational resources, governing policies, infrastructure, etc.). Although not depicted in FIGS. 1 and 2, the classifiers likely output the extracted feature vector to the interface 113 to provide contextual data for the classifications and probabilities.

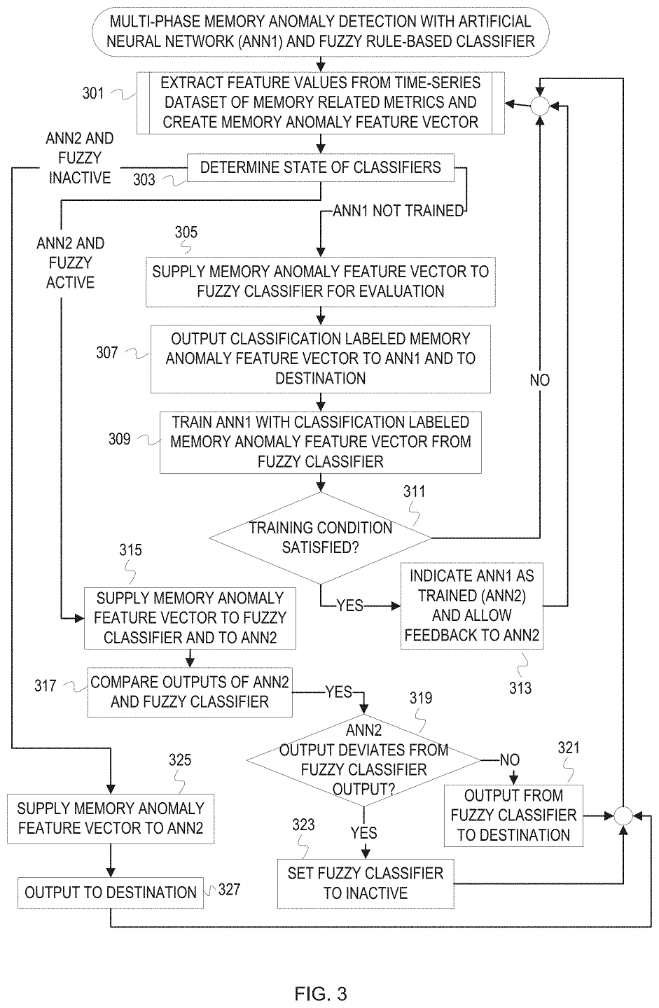

FIG. 3 is a flowchart of example operations for multi-phase memory anomaly detection with an artificial neural network and a fuzzy rule-based classifier. The description of the example operations refers to a detector as performing the operations. The example operations encompass a first phase in which the fuzzy rule-based classifier communicates memory anomaly detection classifications with probability values to a destination for analysis as part of monitoring and managing performance of an applications. During this first phase, the outputs of the fuzzy rule-based classifier are also used to train the ANN until the ANN takes over in a second phase.

A lightweight memory anomaly detector extracts memory anomaly related feature values from a time-series dataset of memory related metrics for a virtual machine of an application (301). The time-series dataset has time-series values for different metrics. Examples of the metrics include application load, memory allocated to the virtual machine, memory in use by the virtual machine, GC operation invocations, and GC operation duration. The GC operation metrics may exist for different types of GC operations. With the extracted feature values, the detector creates a memory anomaly feature vector.

The lightweight memory anomaly detector determines states of the two classifiers: the fuzzy rule-based classifier and the ANN (303). If the ANN has not yet been indicated as trained, then the detector proceeds to supplying the memory anomaly feature vector as input to the fuzzy rule-based classifier for evaluation (305). Based on the fuzzy rule-based classifier applying the weighted pattern-based rules to the memory anomaly feature vector, the fuzzy rule-based classifier outputs a classification labeled memory anomaly feature vector to the untrained ANN (ANN1) and the destination that has been specified to the detector (e.g., in a configuration, a request message, etc.) (307). The classification labeled memory anomaly feature vector is the memory anomaly feature vector associated with the labels corresponding to anomaly and no anomaly as well as the corresponding probabilities or confidence values. This can be implemented with a data structure chosen by the developer.

With the output from the fuzzy rule-based classifier, the ANN1 trains itself (309). The components of the extracted memory anomaly feature vector will be input into the ANN1 and feed forward until probability outputs are produced by the output layer. Backpropagation then revises the internal weights based on the probability values from the fuzzy classifier.

Before a next extracted memory anomaly feature vector is fed to the ANN1, the detector determines whether a training condition has been satisfied (311). A training condition can be threshold specified in various terms. Examples of the training condition threshold include number of input vectors, number of training runs, and time period of data. This is chosen based on an expectation of when the ANN1 will converge with the fuzzy rule-based classifier. If the training size threshold has not been satisfied, then the detector proceeds to process the next time-series dataset. If the training size threshold has been satisfied, then the detector indicates that the ANN1 has been trained (and is now referred to as ANN2) and allows feedback to be supplied to ANN2 (313). This feedback can be obtained from a user interface that allows a user to indicate whether behavior of an application component (e.g., a virtual machine) as represented by a vector of extracted feature values corresponds to anomalous behavior related to memory use/management.

An optional phase allows for the fuzzy rule-based classifier to continue being active with ANN2 and still provide outputs to the destination. Since ANN2 has been trained by the fuzzy rule-based classifier, it should produce the same outputs. However, feedback to ANN2 causes revisions to ANN2 that will eventually cause ANN2 to diverge from the fuzzy rule-based classifier. When the detector determines that both ANN2 and the fuzzy rule-based classifier are active (303), the detector supplies the memory anomaly feature vector to both classifiers (317). The detector compares the outputs of both classifiers (317) to determine whether ANN2 is deviating from the fuzzy rule-based classifier. If ANN2 deviates, then the detector sets the fuzzy rule-based classifier to inactive (323). Otherwise, the detector selects the classification labeled memory anomaly feature vector from the fuzzy classifier to output to the destination (321).

When the detector determines that ANN2 is active but the fuzzy rule-based classifier is inactive (303), the detector supplies the memory anomaly feature vector to ANN2 (325). The fuzzy rule-based classifier is no longer used because it has not adapted to the behavior of the application. The detector then outputs to the destination the probabilities for each class from the ANN2 and the memory anomaly feature vector the destination.

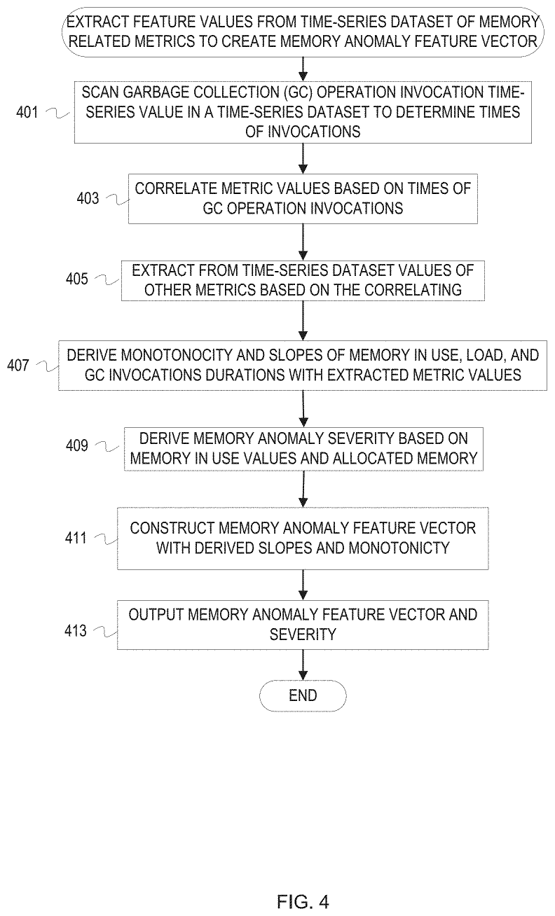

FIG. 4 is a flowchart of example operations for extracting feature values from a time-series dataset of memory related metrics for an application to create the memory anomaly feature vector. The example operations of FIG. 4 are an example implementation for 301 in FIG. 3. The description of FIG. 4 refers to an extractor as performing the example operations.

The extractor scans GC operation invocation time-series values in the time-series dataset to determine times of GC operation invocations (401). The extractor searches through the GC operation invocation time-series values for non-zero values to track the associated times of those invocations. In some cases, the time-series values for GC operation invocations may not include zero values (i.e., not include times when GC operations were not invoked). For those cases, the extractor can track the times indicated in the GC operation invocation time-series values.

Based on the identified times of GC operation invocations, the extractor correlates values of other metrics (403). The extractor determines values in the time-series values of other metrics in the time-series dataset at the times of the GC operations invocations. Since the impact of the GC operation invocations upon other metrics do not necessarily align at the same time, the extractor can determine time sub-windows based on the GC operation invocation times and a defined time margin (e.g., 5% of an interval size or 5 seconds). A single time margin can be applied across metrics or at least some metrics can have specific time margins.

The extractor then extracts from the time-series dataset values of the other metrics based on the correlating (405). The extractor can mark or record the values that occur at the same times as the GC operation invocations and/or within the time sub-windows determined by the extractor.

The extractor uses the extracted time-series values to derive monotonicity and slopes (407). The extractor can derive a net slope of memory in use across the time span corresponding to the time-series dataset based on the memory in use values extracted based on the correlating. The extractor can also determine incremental slopes based on the time-series memory in use values extracted based on the correlated. The extractor can also derive these slopes for other metrics, such as load values and the extracted GC operations duration values. The slopes and monotonicity are considered the features for memory anomaly detection by the classifiers. The extractor also derives a severity of memory anomaly based on the extracted memory in use values and extracted allocated memory values (409).

The extractor constructs a memory anomaly feature vector with the extracted features (411). The extracted feature values include the derived values that were determined from the time-series values extracted based on the correlating, although severity is not included in the vector. The extractor then outputs the memory anomaly feature vector and the severity value.

Adaptive Baseline for Filtering Metric Values for Anomaly Analysis

Although the discussed memory anomaly detector reduces the features fed into the classifiers to achieve a lightweight solution, the classification process still consumes resources. While canonical behavior or a baseline for an application can be established for selective use of the classifiers, an application's canonical behavior cannot be presumed as static. The load on an application can be dynamic and the underlying infrastructure of an application can change. For instance, changes in networking or computing hardware can be made to the infrastructure. Adapting the behavior baseline as represented by feature values avoids feeding in feature values that correspond to canonical behavior and reduces resource consumption. In addition, filtering out feature values that correspond to canonical behavior can reduce both false positives and false negatives that could occur due to fluctuations in load, for example, without adaptive baselining.

To adapt anomaly detection to changing canonical behavior and reduce the chances of feeding in feature value combinations that appear to be outliers but correspond to canonical behavior, multi-variate non-parametric density estimation, such as multi-variate kernel density estimation, is employed. An adaptive canonical behavior filter builds a sample dataset from observed time-series values of memory related metrics and then performs kernel density estimation on the sample dataset. With the resulting probability density function, the adaptive canonical behavior filter filters out subsequently observed time-series values of the memory related metrics that fall within a canonical behavior range that is specified/configured.

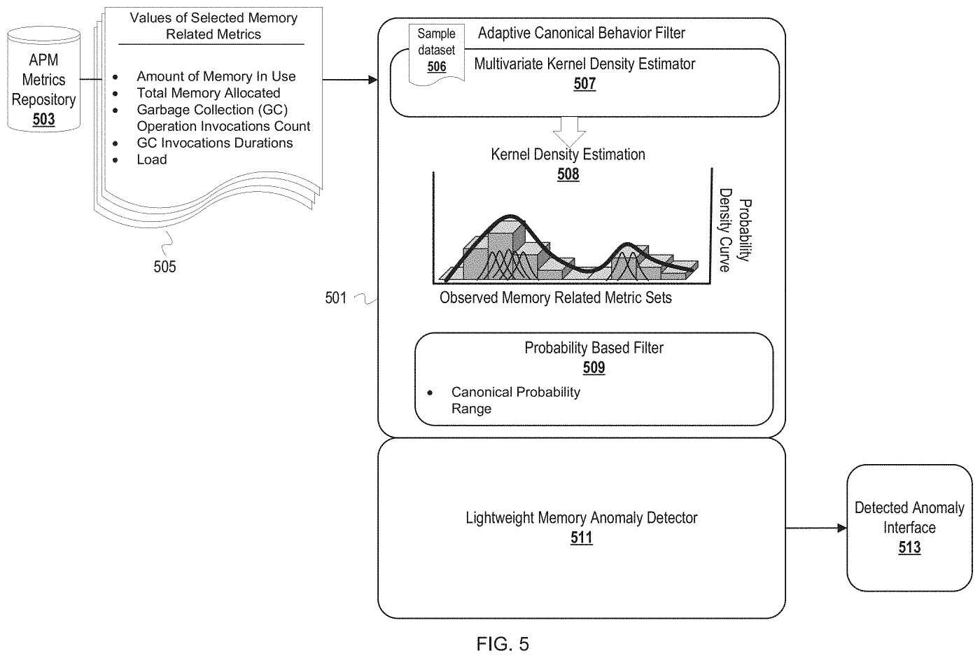

FIG. 5 is a conceptual diagram of an adaptive canonical behavior filter to filter out time slices of time-series values of metrics related to application behavior based on an adapting behavior baseline. Similar to the previous illustrations, time-series values of selected memory related metrics 505 are obtained from an APM metrics repository 503. However, an adaptive canonical behavior filter 501 filters obtained time-series values that likely represent canonical behavior. The adaptive canonical behavior filter 501 forwards those time correlated time-series values (“time slices”) that are determined to fall outside of a probability range defined as a range corresponding to canonical behavior to a lightweight memory anomaly detector 511. The adaptive canonical behavior filter 501 comprises a multivariate kernel density estimator 507 and a probability based filter 509. The adaptive canonical behavior filter 501 operates in two phases that can overlap. In the first phase, the multivariate kernel density estimator (“estimator”) 507 determines a probability density function for a next window of time-series data or prospective time-series dataset. With the probability density function, the probability based filter 509 filters metric time slices based on a probability range defined for canonical behavior.

To determine the density probability function, the estimator 507 builds a sample dataset 506 from the time-series values 505. After sufficient sample data has been collected, the estimator 507 performs a kernel density estimation to build a probability density function (508).

The probability based filter 509 applies the probability density function to time slices received subsequent to determination of the probability density function. A probability range will be defined for canonical behavior. After generating a probability value from the probability density function for a time slice of metric values, the probability based filter 509 determines whether the probability value falls within the defined probability range for canonical behavior. If it does, then the time slice is filtered out and not forwarded to the anomaly detector 511. For those time slices that fall outside of the canonical probability range, the probability based filter 509 communicates or passes the time slice of metric values to the memory anomaly detector 511 for anomaly analysis that will generate an event to be consumed by the detected anomaly interface 513.

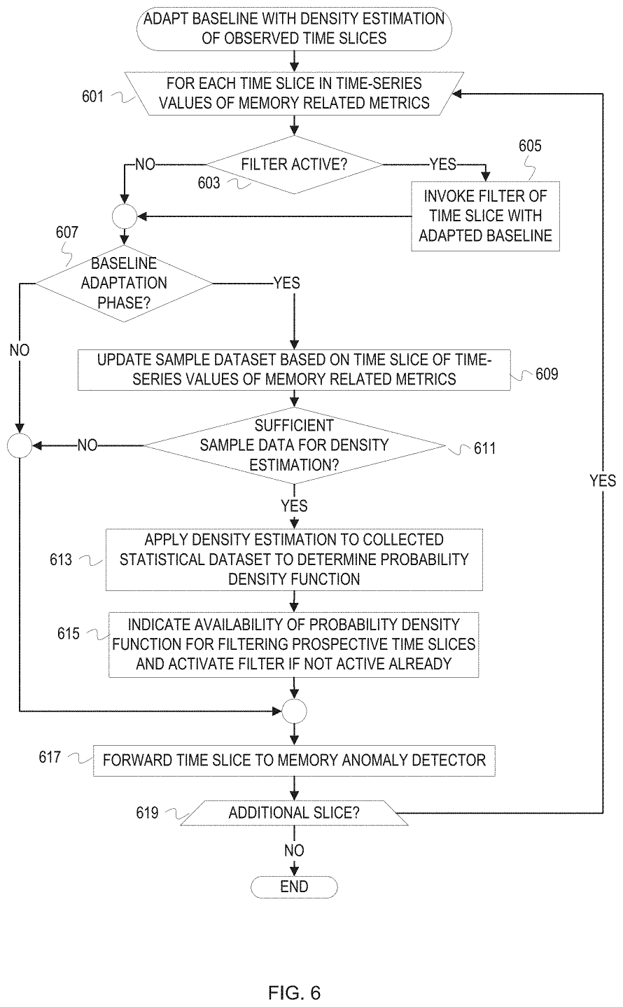

FIG. 6 is a flowchart of example operations for adapting a baseline of canonical behavior with density estimation of observed time slices of metric values. The description of FIG. 6 refers to an adaptive filter as performing the example operations to be consistent with FIG. 5, but in shorthand form.

An adaptive filter will obtain time-series values for specified metrics of an application. The specified metrics relate to an attribute of an application or application component being monitored for anomalies. As previously discussed, a scanner can scan particular containers or paths in a metric repository to read the time-series values that have been collected. These metric value are correlated by time and referred to as a time slice of correlated metric values or “time slice.” This does not require the values to align to a same time instant. Metric values can be correlated based on a range of time or upon a time instant with a defined margin of variance. At startup, the adaptive filter operates in the first phase of building a sample dataset to eventually build a probability density function. After an initial probability density function has been built, the adaptive filter can be programmed to filter time slices for a defined time period or number of time slices before resuming the first phase and operating in both phases: 1) applying the probability density function to obtained time slices for a current time window, and 2) using the time slices of the current time window build a new sample dataset to build a new probability density function, thus adapting the canonical baseline.

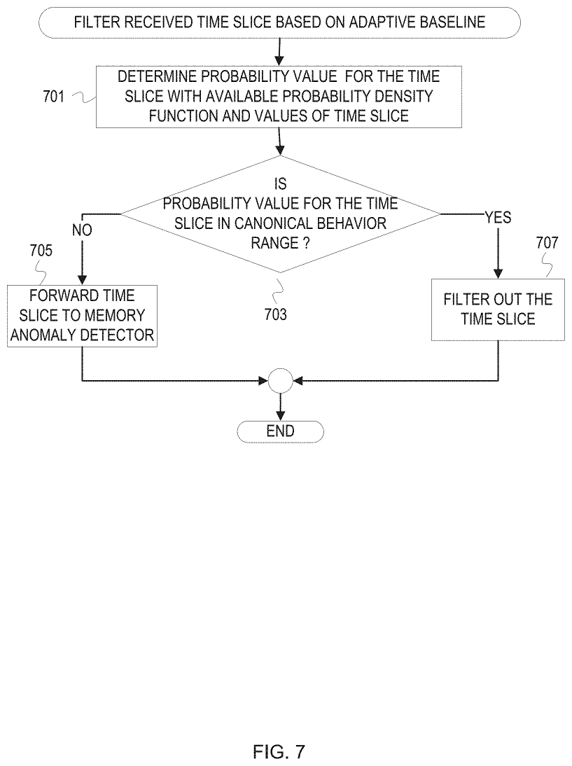

For each time slice of metric values (601), the adaptive filter processes the time slice according to different execution paths depending upon state of the filtering and the baseline adaptation phase. The adaptive filter determines whether the filtering is active (603). The filter should be active if a probability density function has been built and is available. If the filtering is active, then the adaptive filter invokes the filter for the time slice with a current adapted baseline (605). Example filtering operations are depicted in FIG. 7.

If the filtering is not active or after invocation of the filtering, the adaptive filter determines whether a baseline adaptation condition is satisfied (607). The baseline adaptation condition indicates whether the adaptive filter should adapt the baseline by collecting additional or new sample dataset to build a probability density function. The baseline adaptation condition can be an expiration period. For example, a probability density function may be considered as valid for one month. At the end of the month, the probability function expires. Assuming density estimation is performed with one week of time slices, the adaptive filter can start building a sample dataset for density estimation the week before the current probability density function is set to expire. A baseline adaptation phase can also be triggered with non-time criteria. For example, the baseline adaptation phase condition may be satisfied if load (e.g., number of connections, requests, computation units, etc.) on an application has a rate of change beyond a threshold that is sustained for a given time. If the baseline adaptation condition is not satisfied, then the adaptive filter forwards the time slice to the memory anomaly detector (617).

If the baseline adaptation phase condition is satisfied, then the adaptive filter updates the sample dataset based on the time slice of values of the memory related metrics (609). The adaptive filter can maintain the sample dataset as an array of time slices or matrix of time values correlated by time.

After the sample dataset is updated, the adaptive filter determines whether the sample dataset is sufficient for density estimation (611). Sufficiency of the sample dataset can be defined in terms of time (e.g., one week of data) or size (e.g., number of time slices). If the sample dataset is insufficient, then the adaptive filter allows the time slice to pass to the memory anomaly detector (617).

Once the sample dataset is sufficient, the adaptive filter applies density estimation to the collected sample dataset to determine a probability density function (613). An example of a density estimation technique is kernel density estimation (“KDE”). The adaptive filter performs kernel density estimation on the sample dataset to generate a probability density function. The probability density function (“PDF”) may be constructed using a KDE function call that passes in the sample dataset as a matrix. An example KDE is given for illustrative purposes:

$$\hat{f} ( \vec{x} ) = \frac{1}{Nh} {\sum }_{i = 1}^{N} K ( \frac{\vec{x} - {\vec{x}}_{i}}{h} ) \qquad ( 1 )$$

In the above equation, \hat{f} is the approximated PDF, N is the number of time-slices \vec{x}ᵢ in the sample dataset, h is the smoothing factor for the KDE, and K is a generic kernel operator. In some embodiments, Gaussian functions may be used as the kernel for the KDE.

After determining the probability density function from the density estimation on the sample dataset, the adaptive filter indicates the probability density function as available (615). This indication of availability allows an active filter to use the probability density function (PDF) for prospective time slices. The adaptive filter may also mark a currently used PDF as unavailable or replace the prior PDF with the newly determined PDF. In addition, the adaptive filter activates the filter if not already active. The filter is inactive while a probability density function is not available. The filter may be a subprocess or child thread of the adaptive filter.

The adaptive filter forwards the time slice to the anomaly detector (617) and then proceeds to process the next time slice (619).

FIG. 7 is a flowchart of example operations for filtering time slices based on an adaptive baseline as represented by a current PDF. The description of FIG. 7 refers to a filter as performing the example operations.

After receiving a time slice, a filter determines a probability value for the time slice (701). Equation 2 expresses an example estimated probability density function with 1% variance.

$$P ( {\vec{x}}_{n} ) = {\int }_{.99 {\vec{x}}_{n}}^{1.01 {\vec{x}}_{n}} \hat{f} ( \vec{x} ) d \vec{x} = {\int }_{.99 {\vec{x}}_{n}}^{1.01 {\vec{x}}_{n}} \frac{1}{Nh} {\sum }_{i = 1}^{N} K ( \frac{\vec{x} - {\vec{x}}_{i}}{h} ) d \vec{x} \qquad ( 2 )$$

In that equation, P(\vec{x}ₙ) is the probability of a new time slice or data point. The probability is determined by integrating the approximated PDF about the new time slice within 1% error. The deviation of measured values from the approximated PDF may be used to detect candidates for anomaly analysis based on a predetermined probability threshold (e.g., below an n^{th} percentile of distribution).

The filter may receive the time slice in a message or as arguments in a function call or invocation. The filter may be provided references to the time slice (e.g., an index into an array of time slices. The filter computes the probability value with the constituent metric values of the time slice as inputs into the PDF that is indicated as available.

The filter then evaluates the computed probability value against a canonical behavior range to determine whether the probability value for the time slice is within the canonical behavior range (703). As previously stated, the canonical behavior range can at least be defined as a minimum probability value. A computed probability value that is above that minimum is considered as corresponding to canonical behavior and filtered out from anomaly analysis (707). A probability value below that minimum is considered as outside of the canonical range and passed to an anomaly detector (705). The value or values that define the canonical behavior range can be adjusted based on feedback or domain specific knowledge corresponding to the application or application component being monitored and/or the anomaly being searched for by the anomaly detector that consumes the time slice.

Variations

While the examples related to the adaptive canonical behavior filter refer to a memory anomaly detector, embodiments are not so limited. Time-series values for metrics related to a different anomaly can be used for density estimation and producing a probability density function used to filter time slices from analysis by a detector for that different anomaly.

The example illustrations above describe an intermediate phase in which an output is chosen from the trained neural network and the fuzzy rule-based classifier. Embodiments do not necessarily have this intermediate phase and can, instead, deactivate the fuzzy rule-based classifier after the neural network has been trained with the specified training data size.

The example illustrations also describe deriving features based on values extracted based on time correlation across metrics from the GC operation invocation metric. This is done based on an assumption that a local minima and local maximum can be found for the time or time sub-window being used for correlation. Embodiments can derive the slope and monotonicity features across the time-series values of the time-series dataset without reducing the values by correlation. This may burden the compute resources used for extracting, but the classifiers will still be focused on the derived features.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 315, 317, and 318 are not necessary. A detector can deactivate the fuzzy rule-based classifier after the training size threshold for the artificial neural network has been satisfied. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language; a dynamic programming language; a scripting language; and conventional procedural programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

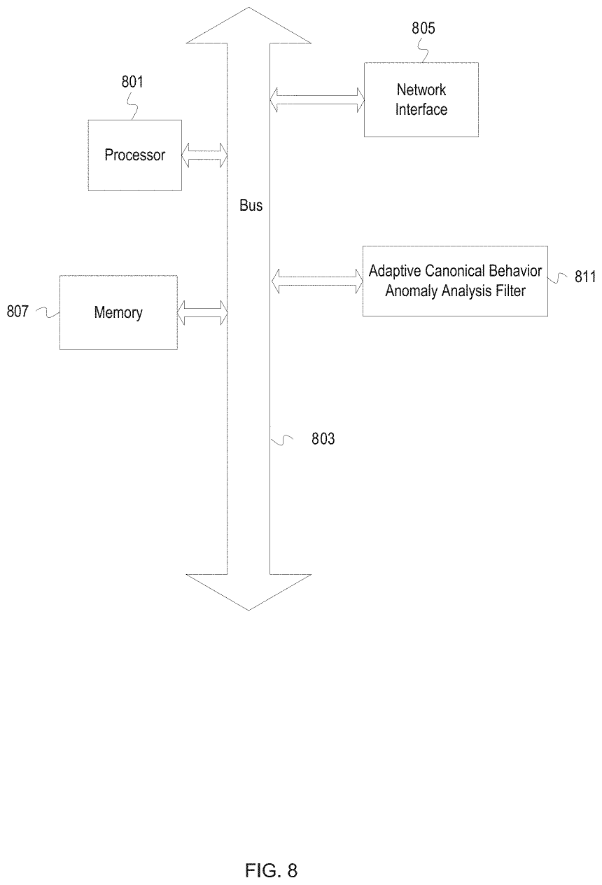

FIG. 8 depicts an example computer system with an adaptive canonical behavior anomaly analysis filter. The computer system includes a processor unit 801 (possibly including multiple processors, multiple cores, multiple nodes, and/or implementing multi-threading, etc.). The computer system includes memory 807. The memory 807 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 803 (e.g., PCI, ISA, PCI-Express, HyperTransport® bus, InfiniBand® bus, NuBus, etc.) and a network interface 805 (e.g., a Fiber Channel interface, an Ethernet interface, an internet small computer system interface, SONET interface, wireless interface, etc.). The system also includes an adaptive canonical behavior anomaly analysis filter 811. The adaptive canonical behavior anomaly analysis filter 811 collects a sample of time slices of time-series values of metrics that have been identified as related to an anomaly of an application attributed (e.g., memory management). With the sample size, the adaptive canonical behavior anomaly analysis filter 811 invokes a density estimation function to produce a probability density function. The probability density function represents a baseline for the identified metric combinations (i.e., canonical behavior of the metrics). The adaptive canonical behavior anomaly analysis filter 811 adapts the baseline (i.e., re-determines the probability density function) after expiration of a time period and/or significant events. The adaptive canonical behavior anomaly analysis filter 811 filters out time slices from anomaly analysis based on the probability function and a probability range defined as corresponding to canonical behavior. Any one of the previously described functionalities may be partially (or entirely) implemented in hardware and/or on the processor unit 801. For example, the functionality may be implemented with an application specific integrated circuit, in logic implemented in the processor unit 801, in a co-processor on a peripheral device or card, etc. Further, realizations may include fewer or additional components not illustrated in FIG. 8 (e.g., video cards, audio cards, additional network interfaces, peripheral devices, etc.). The processor unit 801 and the network interface 805 are coupled to the bus 803. Although illustrated as being coupled to the bus 803, the memory 807 may be coupled to the processor unit 801.

While the aspects of the disclosure are described with reference to various implementations and exploitations, it will be understood that these aspects are illustrative and that the scope of the claims is not limited to them. In general, techniques for non-intrusive, lightweight memory anomaly detection as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
determining with a density estimation function and a first dataset sample a probability density function, wherein the first dataset sample comprises first time slices of first time-series values for a plurality of metrics of an application observed in a first time-series dataset;
for second time-series values of the plurality of metrics in a second time-series dataset after determination of the probability density function,
determining with the probability density function probability values for second time slices of the second time-series values to determine whether values in a time-slice satisfy a canonical behavior range;
filtering out from anomaly analysis those of the second time slices determined to satisfy the canonical behavior range; and
forwarding for anomaly analysis those of the second time slices determined to not satisfy the canonical behavior range.

2. The method of claim 1 further comprising building the first dataset sample while a first indicator indicates that a baseline for canonical behavior has not been established for the second time-series dataset.

3. The method of claim 2, wherein the second time-series dataset is a prospective time-series dataset with respect to the first time-series dataset.

4. The method of claim 1, further comprising:
setting a first indicator to indicate a baseline for a prospective third time-series dataset is to be established based on a baseline adaptation condition being satisfied; and
determining with the density estimation function and a second dataset sample a second probability density function, wherein the second dataset sample comprises third time slices from the second time-series dataset.

5. The method of claim 4, wherein the baseline adaptation condition comprises at least one of a time period and a number of time slices upon which the probability density function has been applied.

6. The method of claim 1, wherein the density estimation function comprises a kernel density estimation function.

7. The method of claim 1, wherein the canonical behavior range at least comprises a defined minimum probability value.

8. The method of claim 1, wherein a time slice comprises a set of values of the plurality of metrics correlated by time.

9. A non-transitory, computer-readable medium having instructions stored thereon that are executable by a computing device to perform operations comprising:
determining with a density estimation function and a first dataset sample a probability density function, wherein the first dataset sample comprises first time slices of first time-series values for a plurality of metrics of an application observed in a first time-series dataset;
for second time-series values of the plurality of metrics in a second time-series dataset after determination of the probability density function,
determining with the probability density function probability values for second time slices of the second time-series values to determine whether values in a time-slice satisfy a canonical behavior range;
filtering out from anomaly analysis those of the second time slices determined to satisfy the canonical behavior range; and
forwarding for anomaly analysis those of the second time slices determined to not satisfy the canonical behavior range.

10. The non-transitory, computer-readable medium of claim 9, wherein the operations further comprise building the first dataset sample while a first indicator indicates that a baseline for canonical behavior has not been established for the second time-series dataset.

11. The method of claim 10, wherein the second time-series dataset is a prospective time-series dataset with respect to the first time-series dataset.

12. The non-transitory, computer-readable medium of claim 9, wherein the operations further comprise:
setting a first indicator to indicate a baseline for a prospective third time-series dataset is to be established based on a baseline adaptation condition being satisfied; and
determining with the density estimation function and a second dataset sample a second probability density function, wherein the second dataset sample comprises third time slices from the second time-series dataset.

13. The non-transitory, computer-readable medium of claim 12, wherein the baseline adaptation condition comprises at least one of a time period and a number of time slices upon which the probability density function has been applied.

14. The non-transitory, computer-readable medium of claim 9, wherein the density estimation function comprises a kernel density estimation function.

15. The non-transitory, computer-readable medium of claim 9, wherein the canonical behavior range at least comprises a defined minimum probability value.

16. The non-transitory, computer-readable medium of claim 9, wherein a time slice comprises a set of values of the plurality of metrics correlated by time.

17. An apparatus comprising:
a processor; and
a machine-readable medium having program code executable by the processor to cause the apparatus to,
determine with a density estimation function and a first dataset sample a probability density function, wherein the first dataset sample comprises first time slices of first time-series values for a plurality of metrics of an application observed in a first time-series dataset;
for second time-series values of the plurality of metrics in a second time-series dataset after determination of the probability density function,
determine with the probability density function probability values for second time slices of the second time-series values to determine whether values in a time-slice satisfy a canonical behavior range;
filter the second time slices from anomaly analysis based on the probability values determined for the second time slices.

18. The apparatus of claim 17, wherein the machine-readable medium further has program code executable by the processor to cause the apparatus to build the first dataset sample while a first indicator indicates that a baseline for canonical behavior has not been established for the second time-series dataset.

19. The apparatus of claim 17, wherein the machine-readable medium further has program code executable by the processor to cause the apparatus to:
set a first indicator to indicate a baseline for a prospective third time-series dataset is to be established based on a baseline adaptation condition being satisfied; and
determine with the density estimation function and a second dataset sample a second probability density function, wherein the second dataset sample comprises third time slices from the second time-series dataset.

20. The apparatus of claim 17, wherein the program code to filter the second time slices from anomaly analysis comprises program code executable by the processor to cause the apparatus to determine, for each of the second time slices, whether the corresponding probability value satisfies a canonical behavior range.
